(19) United States
(12) Patent Application Publication
(10) Pub. No.: US 2017/0241564 A1
(43) Pub. Date: Aug. 24, 2017

(54) VALVE OPERATOR ASSEMBLY, VALVE EQUIPPED WITH SUCH ASSEMBLY AND ASSEMBLY PROCESS FOR SUCH A VALVE

(71) Applicant: Aktiebolaget SKF, Goteborg (SE)

(72) Inventors: Christian Boch, Chambery (FR); Jerome Dubus, Aix Les Bains (FR)

(21) Appl. No.: 15/501,038

(22) PCT Filed: Aug. 5, 2014
(86) PCT No.: PCT/EP2014/066858

§ 371 Date: Feb. 1, 2017

(51) Int. Cl. F16K 31/50; F16K 27/04

(52) U.S. Cl. CPC F16K 31/50; F16K 27/04

(57) ABSTRACT

The invention concerns a valve operator assembly for valve. The valve provides a valve body and a valve translating member axially moveable. The valve operator assembly provides a housing adapted to be mounted on the valve, an input member rotatably mounted with respect to the housing, and a transmission mechanism. The transmission mechanism provides a translating element connected to the valve translating member and a rotating element connected to the input member, the transmission mechanism being adapted to convert applied rotation of the input member into axial translation of the translating element. The valve operator assembly further provides a spacing element adapted to be connected on the valve body on one end and on the housing on the other end, the spacing element having an almost tubular shape defining an axial bore through which at least partly passes the valve translating member and the translating element of the transmission mechanism.

### CROSS REFERENCE TO RELATED APPLICATIONS

This is a United States National Stage Application claiming the benefit of International Application Number PCT/EP2014/066858 filed on Aug. 5, 2014 which is incorporated herein by reference in its entirety.

### FIELD OF THE INVENTION

The present invention relates to the fields of valves and manually operable valves, for instance gate valves, control or regulation valves or choke valves. More particularly, the invention relates to a valve operator assembly for a gate valve.

### BACKGROUND OF THE INVENTION

Valves are used in a variety of industries to control the flow of fluids. In particular, gate valves are used extensively in the oil and gas industry to control the flow of produced fluids at various stages of drilling or production. Most gate valves used in this industry provide a valve body having a longitudinal flow bore and a transverse gate cavity that intersects the flow bore. A gate having an opening extending transversely therethrough is disposed in the gate cavity. A valve stem is provided for moving the gate between an open position, in which the gate opening is aligned with the flow bore, and a closed position, in which the gate opening is offset from the flow bore. The gate cavity of the valve body is covered by a bonnet having an axial bore through which passes the valve stem.

Such a gate valve is associated to a valve operator assembly for selectively driving the valve stem up and down in order to close and open the gate valve. A valve operator assembly generally provides an input member to exert a rotational motion by a manual actuation by a hand-wheel or an electric or pneumatic or hydraulic actuation. The valve operator assembly further provides a transmission mechanism to convert a rotational motion into axial motion of the valve stem. To quickly open and close the gate valve with a minimum number of turns, the transmission mechanism may be a screw mechanism, such as a roller screw mechanism, a ball screw mechanism or an acme screw with or without gear reducer, in order to reduce the operating torque.

The transmission mechanism generally provides a translating element connected to the valve stem and a rotating element connected to the input member, the transmission mechanisms being radially surrounded by a housing.

During the assembly of the gate valve with the valve operator assembly, the valve stem has to be connected to the translating element of the transmission mechanism and then the valve bonnet has to be connected to the housing of the valve operator assembly.

The housing axial length has to be designed so as to accommodate the full screw length, i.e. a first given length being an effective displacement length, a second given length of a portion for connecting the screw to the valve stem and a third given length for permitting the screw to axially extend out of the housing. Without this third screw length, the screw portion for connecting the screw to the valve stem is inaccessible.

However, this third screw length does not have any other utility than attaching the valve stem to the screw during the assembly process. It is then an ineffective length of the screw during the use of the valve operator. Therefore this third screw portion is provided with a length as reduced as possible for material and costs saving.

However, the accessible space for an operator to assemble the valve stem to the screw is strongly reduced whereas it is a long and complex process since the screw displacement length and the gate stroke position have to be accurately set.

### BRIEF SUMMARY OF THE INVENTION

It is therefore a particular object of the present invention to overcome these aforementioned drawbacks by providing a valve operator assembly of simple design that is easy to assemble, economical, able to operate for a long time in both an effective and an economic manner.

The invention concerns a valve operator assembly provided for a valve comprising a valve body and a valve translating member axially moveable, the valve operator assembly comprising a housing adapted to be mounted on the valve, an input member rotatably mounted with respect to the housing, and a transmission mechanism comprising a translating element adapted to be connected to the valve translating member and a rotating element connected to the input member, the transmission mechanism being adapted to convert applied rotation of the input member into axial translation of the translating element.

According to the invention, the valve operator assembly further provides a spacing element adapted to be connected on the valve body on one end and on the housing on the other end, the spacing element having an almost tubular shape defining an axial bore through which passes at least partly the valve translating member and the translating element of the transmission mechanism.

According to further aspects of the invention, which are advantageous but not compulsory, such a valve operator assembly may incorporate one or several of the following features as long as there is no contradiction:

The transmission mechanism is a screw mechanism, wherein the translating element is a screw with a threaded outer surface and the rotating element is a nut with a threaded inner surface.

The transmission mechanism is a screw mechanism, wherein the translating element is a nut with a threaded inner surface and the rotating element is a screw with a threaded outer surface.

The transmission mechanism is a roller screw mechanism wherein rollers are provided between the screw and the nut. Alternatively, the transmission mechanism is a ball screw mechanism wherein balls are provided between the screw and the nut.

The input member is an operable hand-wheel. Alternatively, the input member is a mechanical operator or a remote operating vehicle.

The input member is directly connected to the rotating element. Alternatively, an adapter sleeve is axially mounted between the input member and the rotating element.

The valve operator assembly provides at least one bearing radially mounted between an outer surface of the rotating element and an inner bore of the housing.

The spacing element provides a tubular portion cooperating with a tubular portion of the housing so as one of the tubular portions is radially surrounding the other in order to ensure an axial guidance.

The tubular portion of the spacing element is provided with a thread cooperating with an associated thread provided on the tubular portion of the housing.

The thread of the spacing element is provided on an external cylindrical surface of the tubular portion and the thread of the housing is provided on an inner cylindrical surface of the tubular portion inner bore of the housing.

The thread of the spacing element is provided on an inner cylindrical surface of the tubular portion and the thread of the housing is provided on an outer cylindrical surface of the tubular portion of the housing.

The spacing element provides at least a recess wherein are engaged screws passing through radial threaded holes provided on the housing.

The recess of the spacing element consists in an annular groove.

The spacing element provides a first radial annular flange and the housing provides a second radial annular flange, both flanges being connected together.

The two flanges of the spacing element and the housing are connected together by a plurality screws.

The two flanges of the spacing element and the housing are in close vicinity or in direct contact and are connected together by an annular retainer ring comprising an inner groove wherein the two flanges are engaged and axially blocked.

The annular retainer ring is split in two parts connected together by any appropriate means, for example by screws.

At least one the flanges provided on the housing and/or the spacing element consists in an annular ring connected to the outer periphery of the housing and/or spacing element.

The invention also relates to a valve, notably a gate valve, a control or regulation valve or a choke valve comprising a valve body provided with a valve bonnet and a valve housing covered by the bonnet, a valve translating member axially moveable and a valve operator assembly according to any of the preceding embodiments. The valve translating member may be a valve stem or a piston for instance.

The valve bonnet and the spacing element are connected together by any appropriate means. In particular, the bonnet may provide a tubular portion provided with a thread on an external cylindrical surface, the thread cooperating with an associated thread provided on an inner cylindrical surface of an inner bore of the spacing element. Alternatively, the valve bonnet and the spacing element may be glued, welded or connected by screws and bolts passing through openings.

The invention also relates to an assembly process of such a valve comprising the following steps:

The spacing element is connected to the valve bonnet;

The valve translating member is axially extended out of the bonnet at its maximum length;

The translating element of the transmission mechanism is axially extended out of the transmission mechanism and the housing at its maximum length;

The valve translating member and the translating element of the transmission mechanism are connected together;

The rotating member of the transmission mechanism is put in rotation so as to axially move the transmission mechanism and then to put the spacing element and the housing in close vicinity; and

The spacing element and the housing are connected together.

Thanks to this invention, the housing of the valve operator assembly is split in two parts and the assembly process allows enough space for an operator to connect and adjust the accuracy of the connection between the valve translating member and the translating element of the transmission mechanism. Moreover, new types of connections that were not possible because of the reduced space can now be used.

The screw is set at a minimal effective length since the housing split does not require an extended screw portion for extending out of the housing. It enables material and cost reductions. The system is more compact that could be of great advantage in environment of reduced free space such as complex trees or manifolds.

Another advantage is that the housing can be standardized for any given valve; only the spacing element has to be designed relative to the valve characteristics. It reduces the manufacturing costs of the valve operator assembly.

Furthermore, the maintenance process is eased since it permits an extra stroke on the valve stem so that it can be sealed on a backseat, in particular when valve seals have to be replaced.

### BRIEF DESCRIPTION OF THE SEVERAL VIEWS OF THE DRAWING

The present invention and its advantages will be better understood by studying the detailed description of specific embodiments given by way of non-limiting examples and illustrated by the appended drawings on which:

FIG. 1 is a cross-section of a valve operator assembly for gate valve according to a first example of the invention,

FIGS. 2a to 2c are cross-sections of the assembly process of a valve operator assembly for gate valve according to the first example of the invention,

FIG. 3 is a perspective view of an intermediate spacing part valve according to the first example of the invention,

FIG. 4 is a detail view of FIG. 1,

FIGS. 5a to 5c are detail views of a valve operator assembly for gate valve according to a second example of the invention,

FIGS. 6a and 6b are detail views of a valve operator assembly for gate valve according to a third example of the invention, and

FIG. 7 is detail view of a valve operator assembly for gate valve according to a fourth example of the invention.

### DETAILED DESCRIPTION OF THE INVENTION

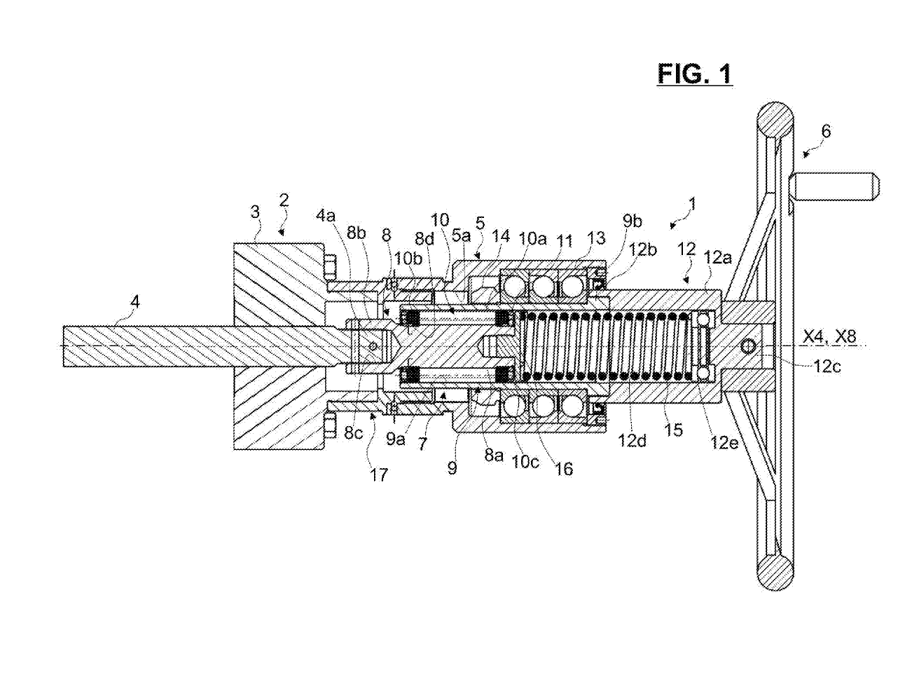

A valve operator assembly 1 as shown in FIG. 1 is adapted for a gate valve 2 provided with a bonnet 3, a valve housing (not shown in the appended drawings) covered by the bonnet and a moveable valve stem 4 of axis X4. Conventionally, the valve body has a flow bore and a transverse gate cavity that intersects the flow bore. The gate valve also provides a gate having an opening extending transversely therethrough is disposed in the gate cavity. For more detail on such a gate valve, it could be referred to EP-B1-1 419 334 (SKF which is hereby incorporated by reference. The bonnet 3 has a sealing function for the valve body and a fixing function between the gate valve 2 and the valve operator assembly 1.

The valve operator assembly 1 provides a tubular housing 5, an input member 6 rotatably mounted with respect to the housing, and a transmission mechanism 7. The transmission mechanism 7 is mounted into a bore 5a of the housing 5 and is connected to the input member 6 on one end and to the valve stem 6 of gate valve 2 on the other end. The transmission mechanism 7 is then axially interposed between the input member 6 and the valve stem 4 to convert a rotational motion of the input member 6 into axial motion of the valve stem 4. In the illustrated example, the bore 5a has a stepped form.

In the example illustrated in FIG. 1, the transmission mechanism 7 is an inverted roller screw mechanism comprising a screw 8, a nut 9 and rollers 10. The screw 8 has an axis X8 coaxial with the axis X4 of the valve stem 4, and is provided with a threaded outer surface 8a. The nut 9 is mounted coaxially about the screw 8 and is provided with a threaded inner surface 9a. A plurality of longitudinal rollers 10 is disposed radially between the screw 8 and the nut 9.

The screw 8 extends longitudinally through a cylindrical bore of the nut 9 on which the threaded inner surface 9a is formed. The nut 9 has a tubular form and is elongated to accommodate the full extent of screw travel. Axially on the side opposite to the input member 6, a recess 8c is formed on a frontal radial surface of an end 8b of screw 8 and into which is fixed an end 4a of the valve stem 4 of the gate valve 2. The valve stem 4 and the screw 8 are connected by any appropriate means, for example by threads, welding, glue, a clamp and/or a pin.

The rollers 10 are identical to each other and are distributed regularly around the screw 9. Each roller extends along an axis which is coaxial with the axis X8 of the screw 8 and provides an outer thread 10a engaging the thread 9a of the nut 9 and the thread 8a of the screw 8. Each roller 10 also provides, at each axial end, outer gear teeth 10b extending axially outwards the outer thread 10a and which are themselves extended axially by a cylindrical stud 10c extending outwards.

The outer gear teeth 10b are meshed by annular gear wheels 8d provided on the outer surface of the screw 8. Each annular gear wheel is axially located near to an end of the threaded outer surface 8a of the screw 8, the threaded outer surface 8a being axially located between the gear wheels 8d.

The cylindrical studs 10c on axial ends of the rollers 10 are housed in cylindrical through-recesses provided on spacer rings 11 (or annular guides). The spacer rings 11 are radially disposed between the screw 8 and the threaded inner surface 9a of the nut 9 without contact with the thread. Each spacer ring 11 is mounted on the outer surface of the screw 8 axially next to an associated gear wheel 8d. The spacer rings 11 are hold on the outer surface of the screw 8 by any appropriate means, for example by an elastic retainer ring (not shown), so as to enable the rollers 10 to be carried and the regular circumferential spacing thereof to be kept.

The valve operator assembly 1 further provides an adapter sleeve 12 axially mounted between the input member 6 and the nut 9. The adapter sleeve 12 provides an axial portion 12a with an annular axial flange 12b on one end that is connected to a flange 9b at an axial end of the nut 9 by any appropriate means, for example by threads. The sleeve 12 further provides a pin 12c that is projected axially outwards from the other end of the axial portion 12a and is connected to the input member 6.

The valve operator assembly 1 further provides three rolling bearings 13 to guide the rotation of the nut 9 of the inverted roller screw mechanism relative to the housing 5. The rolling bearings 13 are radially mounted between the outer surface of the nut 9 and the stepped bore 5a of the housing 5. In the illustrated example of FIG. 1, the rolling bearings 13 are angular contact thrust ball bearings and are axially in contact one to another. A retaining ring 14 is secured on the outer surface of the nut 9 and axially bears against a first rolling bearing 13. Axially on the opposite side, another rolling bearing 13 is axially mounted against the flange 9b of the nut that radially extends outwards the outer surface of the nut 9.

The valve operator assembly 1 further provides a spring 15 axially mounted the screw 8 and the adapter sleeve 12. More precisely, the spring 15 is accommodated within the inner bore 9a of the nut and within an inner bore 12d of the adapter sleeve 12. The inner bore 12d is provided with a stop surface 12e for one end of the spring. The screw 8 is provided with a stop plate 16 at an end on the opposite side of the 8b into which is fixed the valve stem 4, the plate 16 forming a stop for the other end of the spring 15. Alternatively, the valve operator assembly may not provide such an arrangement with a spring.

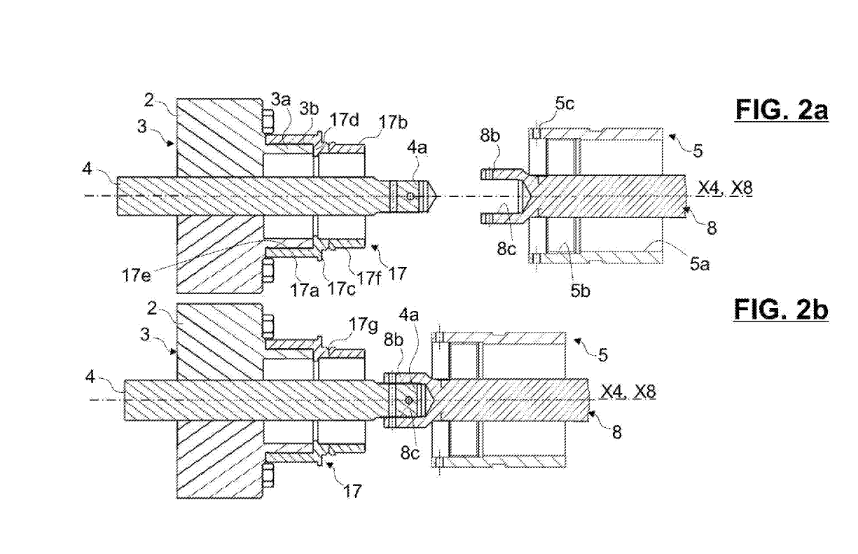

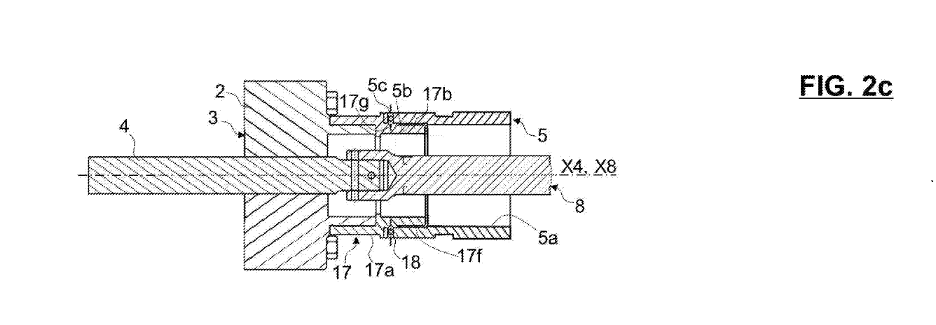

According to the invention, the valve operator assembly further provides a spacing part 17 axially mounted between the bonnet 4 of the gate valve 2 and the housing 5. A spacing part 17 according to a first example of the invention is further described in the FIGS. 2 to 4.

The spacing part 17 provides a first tubular portion 17a and a second tubular portion 17b with different inner and outer diameters. Then the first tubular portion 17a defines an outer shoulder 17c for the second tubular portion 17b, and the second tubular portion 17b defines an inner shoulder 17d for the first tubular portion 17a.

The first tubular portion 17a is provided with a threaded inner cylindrical surface 17e that cooperates with a threaded outer cylindrical surface 3b of a tubular portion 3a of the valve bonnet 3. The inner shoulder 17d forms an axial stop for the tubular portion 3a of the valve bonnet 3. The tubular portions 17a and 3a ensure an axial guidance during the assembly of the spacing element 17 on the bonnet 3.

The second tubular portion 17b is provided with a threaded outer cylindrical surface 17f that cooperates with a threaded inner cylindrical surface 5b of the bore 5a of the housing 5. The outer shoulder 17c forms an axial stop for the housing 5. The tubular portions 17b and 5a ensure an axial guidance during the assembly of the housing 5 on the spacing element 17.

The spacing part 17 further provides a recess, for example an annular groove 17g, provided on an outer cylindrical surface of the second tubular portion 17b. Screws 18 are engaged within the annular groove 17g by passing through radial threaded holes 5c provided on the housing 5. Such arrangement secures the connection between the housing and the spacing element. As an alternative not shown, the spacing part 17 may provide a plurality of recesses, each of them receiving one of the screws 18.

The spacing element 17 defines an axial bore 17h through which passes the valve stem 4 and the screw 8 of the transmission mechanism 7.

According to the FIGS. 2a to 2c, the assembly process of such a valve operator assembly 1 with a gate valve 2 is realized by the following steps:

The spacing element 17 is connected to the valve bonnet 4 of the gate valve 2 by cooperation of the outer cylindrical threaded portion 3b of the tubular portion 3a of the bonnet 3 with the inner cylindrical threaded portion 17e of the tubular portion 17a of the spacing element 17;

The valve stem 4 is axially extended out of the bonnet 3 at its maximum length;

The screw 8 of the transmission mechanism 7 is axially extended out of the transmission mechanism 7 and the housing 5 at its maximum length;

The valve stem 4 and the screw 8 are connected together by inserting and connecting an end 4a of the valve stem 4 into a recess 8c of an end 8b of the screw 8;

The nut 9 of the transmission mechanism 7 is put in rotation so as to axially move the transmission mechanism 7 and then to put the spacing element 17 and the housing 5 in close vicinity; and

The spacing element 17 and the housing 5 are connected together by cooperation of the inner cylindrical threaded portion 5b of the bore 5a of the housing 5 with the outer cylindrical threaded portion 17f of the tubular portion 17b of the spacing element 17 and by engaging screws 18 into the groove 17g of the spacing element 17 by passing through the radial threaded holes 5c provided on the housing 5.

During the step e), the housing 5 may be hold for preventing the housing rotation.

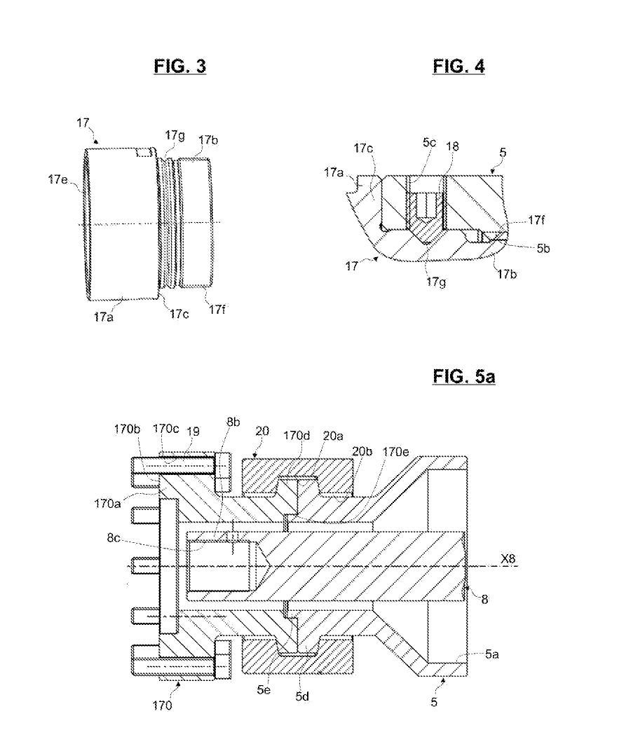

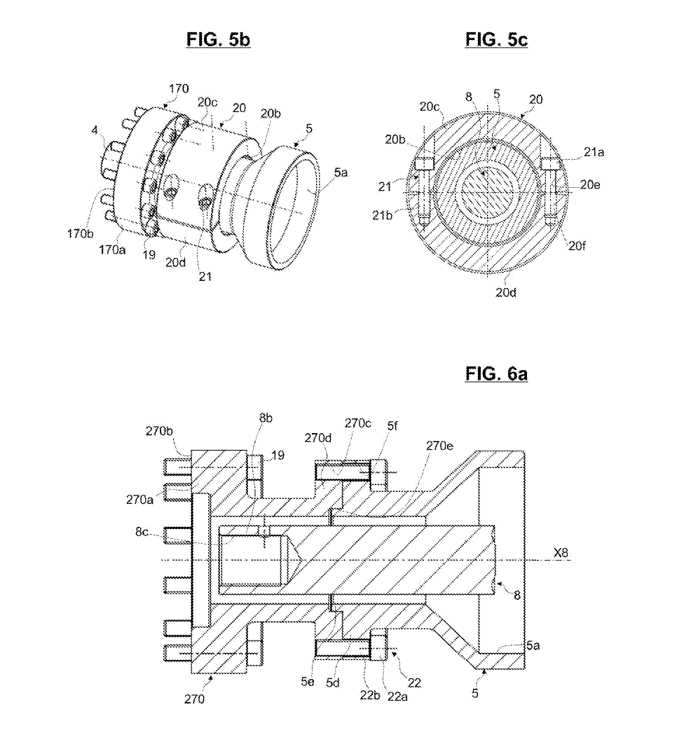

The second embodiment illustrated in FIGS. 5a to 5c, in which identical elements bear the same references, differs from the first embodiment of FIGS. 1 to 4 in that a spacing element 170 is connected to the bonnet 3 by a plurality of screws 19.

The spacing element 170 provides a radial flange 170a defining a radial surface 170b in contact with the bonnet 3. The radial flange 170a provides a plurality of holes 170c which are circumferentially equally spaced wherein screws 19 are engaged. The screws 19 cooperate with associated threaded openings (not shown) provided on a radial surface of the bonnet 3.

The second embodiment of the spacing element 170 also differs from the first embodiment in that the spacing element 170 and the housing 5 provide each radial flanges 170d, 5d respectively which are connected together by an annular ring 20.

The spacing element 170 provides a second radial flange 170d disposed on an end on the opposite direction of the flange 170a connected to the bonnet 3. The radial flange 170d is in contact with a flange 5d of the housing 5 along a radial surface.

The housing 5 further provides an axial tubular portion 5e that fits into an annular recess 170e of the spacing element 170, the axial tubular portion 5e being radially surrounded by the annular recess 170e in order to ensure an axial guidance during the assembly of the housing 5 on the spacing element 170.

The valve operator assembly 1 further provides an annular retainer ring 20 that connects the radial flanges 170d and 5d together. The annular retainer ring 20 provides an inner bore 20b provided with an annular inner groove 20a wherein the two radial flanges 170d and 5d of the spacing element 170 and the housing 5 respectively contacting each other and engaged. The groove 20a forms an axial abutment in both axial directions for the flanges 170d and 5d and then firmly maintains them.

The annular retainer ring 20 is split in two parts 20c and 20d for an easy mounting around the flanges 170d and 5d. It then provides a first part 20c in a shape of a half-circle and a second part 20d in a shape of a half-circle.

The first part 20c provides through holes 20e wherein screws 21 are engaged. Each through hole 20a provides a shoulder forming an abutment for a screw head 21a. A screw threaded portion 21b perpendicularly extending from the head 21a is then engaged in the through hole 20e.

The second part 20d provides threaded openings 20f that cooperates with the threaded portions 21b of the screws 21. A plurality of screws 21 may be arranged within associated through holes 20e on the first part 20c and threaded openings on the second part 20d of the annular retainer ring 20. In the example illustrated in FIG. 5b, one can use 4 screws 21 to connect the two parts 20c, 20d of the annular retainer ring 20.

The assembly process of a valve operator assembly provided with such a spacing element 170 with a gate valve 2 is similar to the one described in the first embodiment of the invention. The differences are the connections:

during the step a) between the valve bonnet 3 and the spacing element 170 by a plurality of screws, and

during the step f) between the housing 5 and the spacing element 170 by contacting their respective radial flanges 170d and 5d and by mounting an annular retainer ring 20 onto the flanges 170d, 5d.

The third embodiment illustrated in FIGS. 6a and 6b, in which identical elements bear the same references, differs from the second embodiment of FIGS. 5a to 5c in that a spacing element 270 and the housing 5 provide each radial flanges 270d, 5d respectively which are connected together by screws 22.

The spacing element 270 provides a radial flange 270d in contact with a flange 5d of the housing 5 along a radial surface. The flange 5d provides a plurality of threaded holes 5f which are circumferentially equally spaced wherein screws 22 are engaged. The screws 22 cooperate with associated threaded holes 270c provided on the radial flange 270d. More precisely, a screw head 22a is in abutment against a radial surface of the flange 5d and a threaded portion 22b perpendicularly extending from the head 22a is engaged in the threaded holes 5f and 270c of the housing 5 and the spacing element 270 respectively.

In the example illustrated in FIG. 6b, one can use 12 screws 22 to connect the housing 5 and the spacing element 270.

The housing 5 further provides an axial tubular portion 5e that fits into an annular recess 270e of the spacing element 270, the axial tubular portion 5e being radially surrounded by the annular recess 270e in order to ensure an axial guidance during the assembly of the housing 5 on the spacing element 270.

The spacing element 270 further provides a radial flange 270a disposed on an end on the opposite direction of the flange 270d, the flange 270a defining a radial surface 270b in contact with the bonnet 3. The radial flange 270a provides a plurality of holes 270c which are circumferentially equally spaced wherein screws 19 are engaged. The screws 19 cooperate with associated threaded openings (not shown) provided on a radial surface of the bonnet 3.

The assembly process of a valve operator assembly provided with such a spacing element 270 with a gate valve 2 is similar to the one described in the first embodiment of the invention. The difference is the connection during the step f) between the housing 5 and the spacing element 270 by contacting their respective radial flanges 270d and 5d and by engaging screws 22 in threaded holes 270c, 5f respectively.

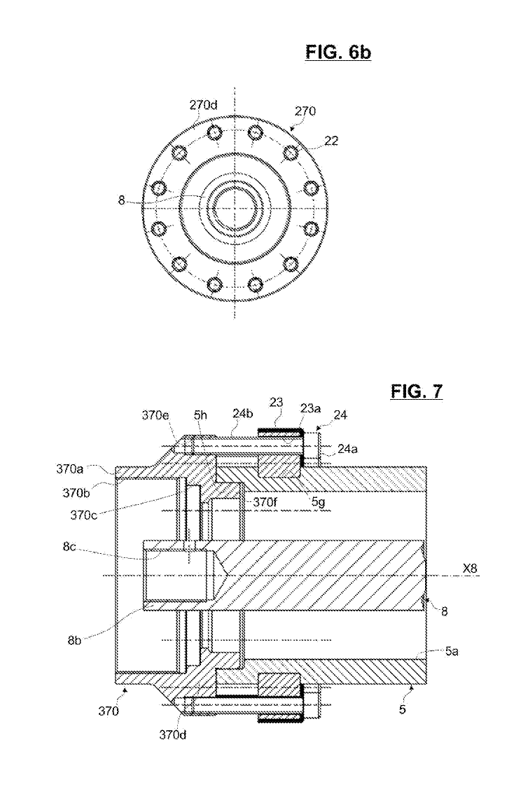

The fourth embodiment illustrated in FIG. 7, in which identical elements bear the same references, differs from the first embodiment of FIGS. 1 to 4 in that a spacing element 370 provides a radial flange 370d and the housing 5 is provided with an annular ring 23, the radial flange 370d and the annular ring 23 being connected together by screws 24.

The spacing element 370 provides a radial flange 370d that is provided with a plurality of threaded holes 370e.

The housing 5 provides an outer groove 5g provided on an outer cylindrical surface of the housing 5, an annular ring 23 being engaged into the outer groove 5g. The annular ring 23 may be press fitted, mounted in force or split in two attached parts in order to be inserted in the outer groove 5g. The annular ring 23 provides a plurality of through holes 23a that face the threaded holes 370e of the spacing element 370.

Screws 24 are inserted in the through holes 23a of the annular ring 23 and the threaded holes 370e of the spacing element 370 in order to connect them together. The screws 24 each provide a head 24a in abutment against a radial surface of the annular ring 23 and a threaded portion 24b that is perpendicularly extending from the head 24a. The threaded portions 24b are engaged in the through holes 23a and cooperate with the threaded holes 370e of the spacing element 370.

The spacing element 370 and the annular ring 23 are then firmly attached by the screws 24. Since the annular ring 23 is axially blocked in the outer groove 5g, the spacing element 370 and the housing 5 are then connected together.

The assembly process of a valve operator assembly provided with such a spacing element 370 with a gate valve 2 is similar to the one described in the first embodiment of the invention. The difference is the connection during the step f) between the housing 5 and the spacing element 370 by the use of an intermediate annular ring 23.

Such a design permits to provide a housing 5 of simple design compared to a housing with a radial flange. It permits to reduce the material used for manufacturing such a housing and then to reduce the cost.

The spacing element 370 further provides a tubular portion 370a on the opposite side of the flange 370d. The tubular portion 370a is provided with a threaded inner cylindrical surface 370b that cooperates with a threaded outer cylindrical surface of a tubular portion of the valve bonnet (not shown but similar to the one if FIGS. 1 and 2a to 2c). An inner shoulder 370c in the inner bore defined by the tubular portion 370a forms an axial stop for the tubular portion of the valve bonnet. The tubular portions ensure an axial guidance during the assembly of the spacing element 370 on the bonnet 3.

Although the present invention has been illustrated using an inverted roller screw mechanism as transmission mechanism, it will be understood that the invention can be applied without major modification to valve operator assembly using any other type of transmission mechanism, such as recirculating roller screw mechanism, ball screw mechanism, friction screw mechanism.

Moreover, although the present invention has been illustrated using a plurality of single-row ball bearings, it will be understood that the invention can be applied without major modification to bearings using rolling elements that are not balls and/or that have several rows of rolling elements.

Although the invention has been illustrated on the basis of a valve operator assembly for gate valve, it should be understood that the invention can also be used with other types of valves, for instance control or regulation valves or choke valves. The valve operator assembly may be used for instance with a surface gate or a subsea valve gate which may be actuated by a remote operating vehicle or an actuator.

The embodiments disclosed in the description may be arranged or combined together and are still within the meaning of the present invention.

1. A valve comprising:
a valve body provided with a valve bonnet,
a valve housing covered by the bonnet,
a valve translating member axially moveable and being a valve stem or a piston,
a valve operator assembly including a housing adapted to be mounted on the valve, an input member rotatably mounted with respect to the housing, and a transmission mechanism comprising a translating element adapted to be connected to the valve translating member and a rotating element connected to the input member, the transmission mechanism being adapted to convert applied rotation of the input member into axial translation of the translating element, wherein
the valve further comprises a spacing element adapted to be connected on the valve bonnet on one end and on the housing on the other end, the spacing element having an tubular shape defining an axial bore through which passes at least partly the valve translating member and the translating element of the transmission mechanism.

2. The valve according to claim 1, wherein the spacing element comprises at least a recess, and wherein engaged screws passing through radial threaded holes are provided on the housing.

3. The valve according to claim 1, wherein the spacing element comprises a tubular portion cooperating with a tubular portion of the housing so as one of the tubular portions is radially surrounding the other in order to ensure an axial guidance.

4. The valve according to claim 3, wherein the tubular portion of the spacing element is provided with a thread cooperating with an associated thread provided the tubular portion of the housing.

5. The valve according to claim 1, wherein the spacing element comprises a first radial annular flange and the housing comprises a second radial annular flange, both flanges being connected together.

6. The valve according to claim 5, wherein the two flanges of the spacing element and the housing are connected together by a plurality screws.

7. The valve according to claim 5, wherein the two flanges of the spacing element and the housing are in close vicinity or in direct contact and are connected together by an annular retainer ring comprising an inner groove, wherein the two flanges are engaged and axially blocked.

8. The valve (2) according to claim 7, wherein the annular retainer ring is split in two parts connected together.

9. The valve according to clam 5, wherein at least one the flanges provided on the housing and/or the spacing element consists in an annular ring connected to the outer periphery of the housing and/or spacing element.

10. (canceled)

11. The valve according to claim 1, wherein the valve bonnet comprises a tubular portion provided with a thread on an external cylindrical surface, the thread cooperating with an associated thread provided on an inner cylindrical surface of an inner bore of the spacing element.

12. The valve according to claim 1, wherein the valve bonnet and the spacing element are connected by screws passing through openings.

13. A process of assembling a valve comprising the following steps:
connecting a spacing element to a valve bonnet;
axially extending a valve translating member out of the bonnet at its maximum length;
axially extending the translating element of the transmission mechanism out of the transmission mechanism and the housing at its maximum length;
connecting the valve translating member and the translating element of the transmission mechanism together;
placing into rotation the rotating member of the transmission mechanism so as to axially move the transmission mechanism and then placing the spacing element and the housing in close vicinity; and
connecting the spacing element and the housing are connected together.
